(19) United States
(12) Patent Application Publication
(10) Pub. No.: US 2023/0295453 A1
(43) Pub. Date: Sep. 21, 2023

(54) FIRE-RETARDANT ADDITIVE WITH FIBERS FOR WATER-BASED PAINTS

(71) Applicant: Edgar Vicente MELCHOR PEREZ, Mexico City (MX)

(72) Inventor: Edgar Vicente MELCHOR PEREZ, Mexico City (MX)

(21) Appl. No.: 17/697,700

(22) Filed: Mar. 17, 2022

(51) Int. Cl. C09D 17/00; C09D 5/14; C09D 5/18; C09D 7/61; C09D 7/63; C09D 7/65; C09D 7/40; C09D 7/43; C09D 7/20

(52) U.S. Cl. CPC C09D 17/001; C09D 5/14; C09D 5/18; C09D 7/61; C09D 7/63; C09D 7/65; C09D 7/70; C09D 7/43; C09D 7/20; C09D 17/008

(57) ABSTRACT

The present invention is related to a tire-retardant composition, specifically directed to an additive with natural fiber components which provide fire retardant properties to water-based paints.

The present invention is related to a fire-retardant composition, specifically directed to an additive with natural fiber components which provide fire retardant properties to water-based paints.

### BACKGROUND OF THE INVENTION

Paint additives are substances added to paints to improve or to modify the physical and chemical properties of paints. Usually, additives are no more than 5% of the paint final composition.

Additives for paints are used mainly for modifying the viscosity, to shorten the drying time, improve its properties against humidity and heat, increase its adherence, increase its penetration, to intensify its shine, for inhibiting the degradation time of its components and to change its temperature, in order to obtain paints with improved consistency when applying them. That is, commercial additives provide improved aesthetic, use, duration, etc., properties.

As shown in Table 1, different types of additives are classified according to the task to be performed.

TABLE 1
Function of various paint additives.

| ADDITIVE | FUNCTION |
|---|---|
| Hardeners or dryers | To accelerate the solidification and hardening |
| | of paints |
| Plasticizers or | Change the elasticity and flexibility properties |
| elastifiers | |
| Wetters | Increase the components homogenization |
| | easiness. |
| Thickeners | Improve the paints consistency, i.e. Its viscosity. |
| Dipersants | Inhibit the formation of lumps during their |
| | storage. |
| Antisettling | Help to preserve suspended pigments. |
| additives | |
| Emulsifiers | Help to obtain a homogeneous blend of components |
| Loads | Change the application texture, such as rugosity. |

One of the relevant uses of additives are as fire-retardants, which notoriously decrease the propagation of fire, which means that the material does not propagate fire from an ignition point, provided that there is no degradation due to heat. Fire retardant additives are necessary as part of the anti-fire structural protection, although they are not sufficient for a full protection, since these additives do not decrease the flammability of the material at the ignition point, do not guarantee the structural stability due to thermal deformation, and do not diminish heat transfer from an exposed side to an unexposed side. Such additives only considerably reduce the undesirable fire propagation property of unsaturated resins.

Another means for decreasing fire risks is the use of intumescent coatings, which are a passive protection against fire. Such coatings are usually applied as a thin film which increases several times its original thickness and forms an isolation carbonaceous remainder.

An intumescent agent is any material which expands when exposed to heat. Intumescent materials are usually used in the construction industry to provide passive protection against fire, and in some cases delay fire propagation for up to one hour. This is achieved by acting as a barrier between the fire and the substrate (such as a steel structure).

Intumescent coatings are often classified according to the type of fire they were designed to protect from, for example fire caused by celluloids or by hydrocarbons.

Intumescent coatings are particularly used for its application on steel structures (for example beams, columns or plates), and other metallic structural components for avoiding collapse and/or structural compromise.

Conventional intumescent coatings are made of a polymer binder, an acid source, a carbonization agent, and a blowing agent.

When intumescent coatings are exposed to fire or excessive heat, the acid source decomposes and forms an acid. The carbonization agent or carbonaceous remnant (carbon source) reacts with the acid and forms a carbonaceous remainder; concurrently, the blowing agent degrades and produces a non-flammable gas (for example ammoniac). The emitted gas forms a foam or expanded carbonaceous remnant. This thick, porous, highly isolating, non-flammable and solid foam protects the substrate which acts as a barrier against incident heat.

Another characteristic of these materials is their capability to transmit heat, i.e., they allow the kinetic energy of their molecules to pass to other adjacent substances. It is an intensive magnitude, inversely proportional to the thermal resistivity (the resistance of certain materials to transmit heat through their molecules).

The explanation of this phenomenon is that when a material is heated, its molecules increase their kinetic energy, that is, become more excited. Hence, molecules are capable of sharing this extra energy without causing global movements of matter (and is distinct from the thermal convection of liquids and gases), a high capability of metals and continuous bodies in general, and very low in polymers and other isolating materials such as fiberglass.

If a material has greater thermal conductivity, it will better conduct heat. With lesser thermal conductivity, the material will be more isolating, Temperature, convection, electric conductivity and phase changes of the material are factors contributing to the thermal conductivity coefficient.

Volatile organic compounds (VOCs) are organic chemical substances having a high vapor pressure at room temperature. A high vapor pressure is correlated to a low boiling point, which in turn is related to the number of molecules of the sample in the surrounding air, a characteristic known as volatility.

Breathing VOCs can irritate the eyes, nose and throat, can cause nausea and difficulty to breathe, and may harm the central nervous system and other organs. Some VOCs may even cause cancer.

A very common VOC is dichloromethane. It is present in paint removers, aerosol solvents and other flame retardants.

TABLE 2
Commercial products and their thermal conductivity properties.
w/m · K (HOT WIRE and VOC methods)

| COMMERCIAL PRODUCT | TC | VOC G/L |
|---|---|---|
| COMEX | 0.29-0.30 | 26.64 |
| COOLWARD | NA | >70 |
| ECOPLASTER | NA | >6 |
| FONOTERMAL | NA | >25 |
| GAINA | 0.30 | NA |
| IMPERLUX | 0.056 | NA |
| I'ATALAYA | 0.10 | NA |
| OSEL | 0.84 | NA |
| SHELLCOAT | 0.88 | NA |
| SHERWIN WILLIAMS | 0.30 | 37.4 |
| SHIELD | 0.10 | NA |
| SIN CALOR | 0.056 | NA |
| SOPGAL | 0.166 | 30 |
| SUBERLEV | 0.050 | NA |
| SURFAPAINT | 0.096 | 0.10 |
| ECOPAINT DEV1.22 | Between 0.026 | 0 |
| | to 0.029 | |

Other technologies can be found with flame retardant functions, the following being the most relevant:

Mexican Patent application MX/a/2018/014661 refers to a composition and process for obtaining a polymeric biocomposite material with flame retardant properties. One of its components is Henequen agave (Agave fourcroydes) fibers, grown in the State of Yucatan, Mexico, used as a flame retardant additive of natural origin. This polymeric biocomposite material is obtained from an extrusion process, employing a biodegradable and compostable biopolymer as the polymeric matrix. The biopolymer is based on starch. Toxic compounds (halogenated)-free commercial flame retardant additives are added. Henequen fibers act synergically as a natural origin flame retardant additive and replace part of a flame retardant commercial additive known as encapsulated ammonium polyphosphate, and a Class VI polymeric biocomposite material is obtained with flame retardant properties, according to UL94 in vertical position method. This material can be utilized in the manufacture of any plastics transformation process of panels or covers for the electric, electronic and transport industries.

U.S. Patent Publication No. US 2011/0073008 provides a biodegradable thermoplastic resin composition, comprising a cellulose derivative and a surface-treated natural fiber Particularly, to a biodegradable thermoplastic resin composition having cellulose derivatives and a surface-treated natural fiber, when subjecting the surface of the natural fiber to an alkali and/or sizing treatment, a mechanical strength of the biodegradable thermoplastic resin composition is improved by increasing the interfacial adhesion between the cellulose derivatives and the natural fiber, to improve the mechanical resistance of the biodegradable thermoplastic resin composition.

U.S. Patent Publication US 2011/0212293 discloses an eco-friendly incombustible biocomposite comprising: a) a polymer matrix comprising a natural fiber; and b) a ceramic sheet laminated integrally with the polymer matrix. The biocomposite is eco-friendly since it uses natural fibers as reinforcement material, and is incombustible since it is integrally laminated with the ceramic sheet. Also, it has a superior storage modulus and dimensional stability as well as enhanced lightness and elastic properties and can be processed in many structures. Hence, it is useful for automotive or indoor/outdoor materials.

International Patent Publication WO2007/020657 discloses a natural fiber thermoset composite product of high tensile strength, high compressive strength, high cross breaking point, low water absorption properties and a method for producing same. The product comprises bamboo and jute fibers, fillers and additives, and the bamboo and jute fibers are present in the ratio of 1:99 to 99:1 of the reinforcement material. The method of manufacture of natural fiber thermoset composite product of high tensile strength, high compressive strength, high cross breaking point, low water absorption properties comprises forming slurry with resin solution, fillers and optional additives; impregnation, spraying, coating of bamboo and jute provided separately or combined in a ratio of 1:99 to 99:1 as reinforcement in the slurry; drying said impregnated/sprayed/coated reinforcement material in oven at a temperature of 100° C. to 200° C.; cutting said impregnated/sprayed/coated and dried fibers or panels into required size; said impregnated/sprayed/coated dried cut pieces of bamboo and jute with or without said other natural fibers multilayered according to require thickness and pressed in the hydraulic press at a pressure 1 to 3 tons per square inches for a definite period at a defined temperature. The composite product is adapted to be used as boards, panel sheets, materials for roofs and the like.

U.S. Pat. No. 4,219,456 discloses a formaldehyde resin solution compatible fire retardant agent solution compatible with formaldehyde resin solutions is prepared consisting essentially of (a) 30 to 75 weight percent of a phosphoric acid containing condensation product of guanidine and formaldehyde in which the molar ratio A of phosphoric acid to guanidine is between 0.7:1 and 1.5:1 and the molar ratio B of formaldehyde to guanidine is between 1.0:1 and 4.0:1 and in which additionally the product of the two molar ratios A and B is from 1.0 to 6.0, and (b) 70 to 25 weight percent of a saturated, straight chain monohydric alcohol having 1 to 3 carbon atoms or a mixture of such an alcohol and up to 25 weight percent, based on the weight of component t (b) of water.

Japanese Patent Publication JP 2002226799 discloses how to provide a release sheet having elasticity capable of accommodating expansion and contraction of an adhesive film, strength capable of withstanding a load when peeling the adhesive film and other external force, and biodegradability enabling disposal processing. The biodegradable release sheet comprises a mixture of starch and an organic substance as main raw materials, and each is a biodegradable resin material and natural fiber materials with a highly reinforcing additive mixed with the main raw materials.

Japanese Patent Publication JP 2002180374 discloses a method for producing a flame-retardant or infusible fiber, to safely avoid the combustion and heat-induced fusion of a fiber. The infusible fiber is manufactured with acrylic-based, vinyl acetate-based, synthetic rubber-based and natural rubber-based methods. Adhesive treating agent consisting of a mixture of one or more kinds of emulsions, starches, carboxymethyl cellulose, methyl cellulose, polyvinyl alcohol, silicone resin emulsion, and natural mineral powders such as clay, zeolite, and clay, titanium oxide, oxidation Antimony, metal oxides such as zinc oxide, inorganic silicon compounds such as sodium silicate, water glass, etc., or heat resistance improving agent consisting of a mixture of one or more kinds of calcium carbonate, slaked lime, coal ash, volcanic ash, etc. It is characterized in that an aqueous film-forming inorganic compound is attached to the surface of flammable or heat-meltable fiber to form a fire resistant/heat resistant film on the surface of the fiber.

### SUMMARY OF EMBODIMENTS OF THE INVENTION

The present invention discloses the manufacturing and use of an additive utilized in a paint which provides flame retardant properties, said additive is characterized by containing rehydrated natural fibers, allowing not only to have a flame retardant function, but to act as a temperature insulator.

Advantageously, this additive mixed with water-based paint improved the durability, thermal insulation and resistance to high temperatures (greater than 550° C.).

In some embodiments, the water-based paint additive comprises, consists of, or consists essentially of water, sodium 2,4,5-trichlorophenolate (Dowicide), tamol, titanium dioxide, calcium carbonate Class B-325, an aqueous antifoaming agent, rehydrated natural fibers, carbopol, sodium methylparaben, triethanolamine, and Methocel, wherein the water-based paint additive comprises a solid component, wherein at least 99% of the solid component is the rehydrated natural fibers.

In some embodiments, the solid component comprises approximately 30% by weight of the water-based paint additive.

In some embodiments, the rehydrated natural fibers in the water-based paint additive comprise one or more of hemp, coconut, palm, and rubber fibers.

In some embodiments, the rehydrated natural fibers in the water-based paint additive consist of one or more of hemp, coconut, palm, and rubber fibers.

In some embodiments, the rehydrated natural fibers are present in the composition in the following quantities (per liter): hemp: 10 g-1000 g, coconut: 10 g-1000 g, palm: 10 g-1000 g, and rubber: 10 g-1000 g.

In some embodiments, the water-based paint additive comprises a thermal conductivity of approximately K=0.026-0.029 British thermal units-inch/hourxfoot²×° Fahrenheit.

In some embodiments, water-based paint additive comprises a Brookfield viscosity of between 40,000-50,000 centipose (CPS).

In some embodiments, the water-based paint additive comprises a density of approximately 1.00 grams/centimeter³ to approximately 1.3 grams/centimeter³, or approximately 1.22 grams/centimeter 3.

In some embodiments, the water-based paint additive comprises an adherence to concrete of at least 96% and an adherence to metals of at least 99%.

In some embodiments, the water-based paint additive has flame-retardant properties or is flame-retardant.

In some embodiments, the water-based paint additive reduces the temperature change of a surface to which the additive is applied by approximately 400° C. compared to an uncoated surface when exposed to direct heat. In other embodiments, the water-based paint additive reduces the temperature change of a metal surface to which the additive is applied by approximately 400° C. compared to an uncoated metal surface when exposed to direct heat. In some embodiments, the direct heat is an open flame.

In some embodiments, the water-based paint additive further comprises a water-based paint in approximately a 1:2 ratio by weight. In some embodiments, the water-based paint additive is mixed with a water-based paint in a 1:2 ratio prior to application to a surface.

The disclosure also provides for a method for manufacturing the water-based paint additive. The method comprises, consisting of, or consists essentially of A) mixing water at approximately 50 degrees Celsius (° C.) in a mixing device at a first speed, then and performing the following steps in order to form a first mixture: i.) combining Dowicide, tamol, titanium dioxide, and calcium carbonate Class B-325 with the water without stopping the mixing; ii.) adding an aqueous antifoaming agent and a viny resin with continued mixing; iii.) adding the rehydrated natural fibers, carbopol, and sodium methylparaben; iv.) increasing the mixing speed to a second speed greater than the first speed and adding Triethanolamine with continued mixing, after which the second speed is decrease to the first speed to form the first mixture; B) adding methocel to the first mixture as a thickening agent, wherein the thickening agent is pre-prepared as follows: v.) combining water with the methocel and mixing to form a second mixture such that the methocel is present in a concentration of approximately 5% to approximately 10% by weight (w/v); vi.) repeating the mixing of the second mixture of step v; vii.) after step vi, adding the second mixture to the first mixture to form a third mixture; C) adding an additional amount of the aqueous antifoaming agent to the third mixture; viii.) continuing the mixing of the third mixture at the first speed to form the water-based paint additive.

In other embodiments, a method for manufacturing the water-based paint additive comprises, consisting of, or consists essentially of A) mixing water at approximately 50 degrees Celsius (° C.) in a mixing device at a first speed and performing the following steps in order to form a first mixture: i.) combining Dowicide, tamol, titanium dioxide, and calcium carbonate Class B-325 with the water without stopping the mixing; ii.) adding an aqueous antifoaming agent and viny resin to the device that is then mixed for approximately 3 minutes; iii.) adding, at approximately 5 minutes intervals, the rehydrated natural fibers carbopol, and sodium methylparaben; iv.) increasing the mixing speed to a second speed greater than the first speed and adding Triethanolamine that is then mixed for approximately 5 minutes, after which the second speed is decrease to the first speed to form the first mixture; B) adding methocel to the first mixture as a thickening agent, wherein the thickening agent is pre-prepared as follows: v) combining water with the methocel and mixing to form a second mixture such that the methocel is present in a concentration of approximately 5% to approximately 10% by weight (w/v), wherein the mixing is first in a clockwise direction, stopping the mixing, and then continuing the mixing of the second mixture in a counterclockwise direction; vi) repeating the mixing of the second mixture of step v for approximately 30 seconds; vii) after step vi, adding the second mixture to the first mixture to form a third mixture; C) adding an additional amount of the aqueous antifoaming agent to the third mixture; viii) continuing the mixing of the third mixture for approximately 40 minutes at the first speed; and ix) letting the third mixture settle for approximately 20 minutes to form the water-based paint additive.

These and other features and advantages of this invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

FIG. 1 is a photograph of a frontal view of the painted sheet

FIG. 2 is a photograph of rear view of the sheet without paint

FIG. 3 is a photograph of a frontal view of the additive for water-based paints performance test. The bare metal surface reaches a temperature of 682 degree Celsius when exposed to direct heat.

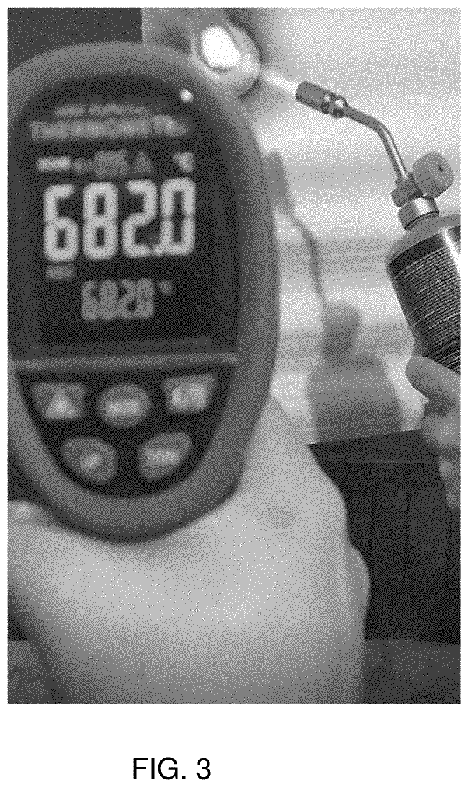

FIG. 4 is a photograph of a rear view of the additive for water-based paints performance test. The surface of the same metal coated with the water-based paint additive only reaches a temperature of 156.4° C. when exposed to the same direct heat as demonstrated in FIG. 3.

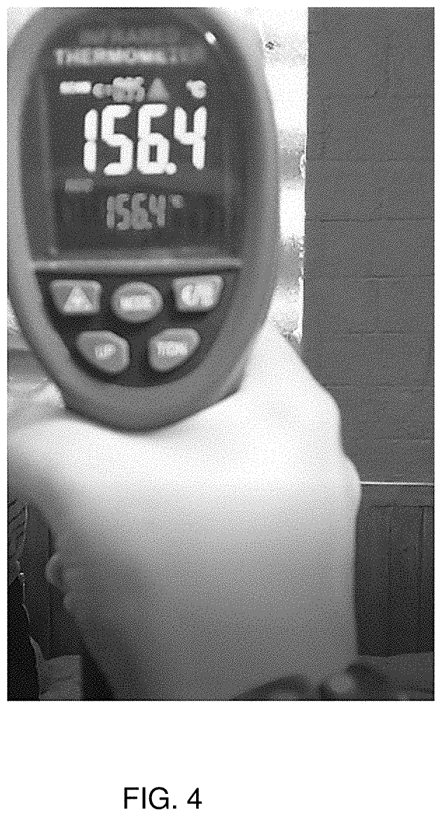

### DETAILED DESCRIPTION

A specific reference is made to the attached claims, figures and description, which all describe elements of the present invention. While specific embodiments are identified, it is understood that the elements of a described aspect can be combined with other aspects separately identified. Likewise, any expert of the art will have the required understanding of the common processes, components and methods, and this disclosure intends to encompass and describe said common aspects, even if they are not expressly identified in the present description.

As has been previously mentioned, paint additives are presently used to provide characteristics and/or functions that are aesthetic or functional.

There are presently some additives intended to be used as flame retardants, in order to decrease the propagation of fire. These additives are manufactured using different chemical active ingredients, such a halogen-free compositions, comprising (meth)acrylate polymers and polyurethanes, wherein the polyurethane is based on polycarbonate polyols and ammonium polyphosphate, among others.

However, these additives are costly, in most cases require specialized preparation and application, are aggressive towards the environment, and cause mid- and long-term harms in the respiratory system.

Accordingly, this invention provides a new additive for water-based paints, containing more than 50% (fifty percent) of hydratable natural fibers. It results in a very practical and low-cost product, easy to use (it only needs to be mixed with the pains), does not release remainders harmful to living beings, and does not affect the environment.

It is an additive that when mixed with water-based acrylic paint, provides flame retardant properties, and is also capable of decreasing the temperature of a whole surface from 550° C. to less than 150° C., and is a thermal insulator.

The additive comprises:
Water;
Sodium 2,4,5-trichlorophenolate (Dowicide);
Tamol;
Titanium dioxide;
Calcium carbonate Class B-325;
Antifoaming agent (the antifoaming agent can be any agent comprising water-based fatty acids, free of vegetal and mineral oils, and silicone emulsion);
Rehydrated natural fibers (hemp, coconut, palm, rubber);
Carbopol;
Sodium methylparaben;
Triethanolamine;
Methocel; and

wherein the rehydrated natural fibers comprise one or more of coconut, palm, rubber, cotton, and hemp.

In some embodiments, the water-based additive comprises a solid component wherein the solid component comprises at least about 90%, at least about 95%, at least about 96%, at least about 97%, at least about 98%, or at least about 99% of the solid component. In some embodiments, the solid component of the water-based additive comprises tamol, titanium dioxide, calcium carbonate Class B-325; an antifoaming agent, rehydrated natural fibers (hemp, coconut, palm, rubber), Carbopol, sodium methylparaben, triethanolamine, and methocel. In some embodiments, the rehydrated fibers comprise at least 99% of the solid component.

In some embodiments, the solid component comprises about 30% of the water-based additive and water comprises about 70% of the water-based additive or the remainder of the water-based additive.

When contacted with water-based paint and water, it releases natural fiber particles and encapsulated air containing the additive with flame retardant and insulating properties. The manufacturing of the additive is at room temperature, and the components are as follows (per liter):
1) Water: 70%
2) Sodium 2,4,5-trichlorophenolate (Dowicide) 50 mg-1000 g
3) Tamol: 50 mg-1000 g
4) Titanium dioxide: 100 mg-1000 g
5) Calcium carbonate Class B-325: 5 mg-1000 g
6) Antifoaming agent (aqueous): 50 mg-1000 g
7) Rehydrated natural fibers:
   Hemp: 10 g-1000 g,
   Coconut: 10 g-1000 g,
   Palm: 10 g-1000 g,
   Rubber: 10 g-1000 g
8) Carbopol 5 mg-1000 mg
9) Sodium methylparaben 5 mg-1000 g
10) Triethanolamine 5 mg-1000 g
11) Methocel 50 mg-1000 g

In some embodiments, a composition may comprise sodium 2,4,5-trichlorophenolate (Dowicide), tamol, antifoaming agent, and Methocel, are each present in a range of about 50 mg, about 100 mg, about 150 mg, about 200 mg, about 250 mg, about 300 mg, about 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, or about 1000 mg, or a range in between any two of the aforementioned integers (for example, about 200 mg to about 800 mg).

In some embodiments, calcium carbonate Class B-325, Carbopol, sodium methylparaben, and triethanolamine are each present in a range of about 5 mg, about 10 mg, about 15 mg, about 20 mg, about 25 mg, 50 mg, about 100 mg, about 150 mg, about 200 mg, about 250 mg, about 300 mg, about 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, or about 1000 mg, or a range in between any two of the aforementioned integers.

In some embodiments, the rehydrated natural fibers hemp, coconut, palm, and rubber each may be present in an amount of about 10 mg, about 20 mg, about 30 mg, about 40 mg, 50 mg, about 100 mg, about 150 mg, about 200 mg, about 250 mg, about 300 mg, about 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, or about 1000 mg, or a range in between any two of the aforementioned integers.

In some embodiments, the titanium dioxide may be present in an amount of about 100 mg, about 150 mg, about 200 mg, about 250 mg, about 300 mg, about 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, or about 1000 mg, or a range in between any two of the aforementioned integers.

In various embodiments, the amount of the components in the water-based paint additive may differ relative to each other. For example, carbopol may be present in an amount of 300 mg while triethanolamine may be present in an amount of 450 mg, or hemp may be present in an amount of 100 mg and coconut fibers present in an amount of 800 mg, or methocel may be present in an amount of 200 mg and titanium dioxide present in an amount of 500 mg, etc.

The process is initiated when pouring water at 50° C. in the mixer, the mixing begins at medium speed and the materials are added in the following order, at 1-minute intervals between one material and the next.
Dowicide, tamol, titanium dioxide and calcium carbonate Class B-325 without stopping the mixing, scratching the lower part of the mixer bar with a paddle until the adhered powders are removed, and incorporating them to the mix.
Pour antifoaming agent (aqueous) and vinyl resin, mix 3 minutes, add at 5-minutes intervals rehydrated natural fibers (hemp, coconut, palm, rubber), Carbopol and sodium methylparaben, increase the mixing speed and add Triethanolamine, mix 5 minutes more and decrease the mixing to medium speed and add Methocel,

Do not add methocel (thickening powder) directly to the tank; the thickener should be prepared as follows:
Pour 3 gallons of water in a container, add 700 grams of the thickener and mix. It should be mixed first clockwise. Then stop the mixing and then mix counterclockwise, repeat these steps for 30 seconds, and then add immediately this mix to the tank. Do not let pass more than 30 seconds to add it, since it can thicken in the container and will not adequately perform its function when adding it to the tank.

Add antifoaming agent (aqueous): 50 mg-1000 g Keep mixing for 40 minutes at medium speed, let the mix to settle for 20 minutes and then pour in containers.

In some embodiments, the water-based paint additive is mixed with a water-based paint in a ratio of about 1:1, about 1:2, about 1:3, about 1:4, about 1:5, about 1:6, about 1:7, about 1:8 about 1:9, or about 1:10. In some embodiments, water-based paint additive is mixed with a water-based paint in a ratio of about 1:2.

The final product has the following specifications:
1) Color: White base paint
2) Toxicity: Non-toxic
3) Emulsifier: Water
4) Drying: 60 minutes (according on thickness, temperature, and humidity)
5) Repainting: 3-4 hours.
6) Binders: Minerals and organics
7) Thermal conductivity K=0.026-0.029 Btu-inch/hr ft²° f
8) UV ray refraction: 85%
9) Brookfield viscosity: Cps 40000-50000 (ASTM D-2196)
10) Water absorption: 0.05% (ASTM D-1653)
11) Density: 1.22 Gr/cm³, with a 10% variation. This allows to apply the mix on any surface without altering de design conditions, with a 20 mills (thousandth of an inch) thickness. With a weight of 0.28 km/m (ASTM D-1475)
12) Minimum recommended thickness 80 mills
13) Nano active material: Self-extinguishing flammability
14) Flexibility: 250%
15) Adherence: 96% on concrete, 99% on metals (ASTM D-1475)
16) Thermal shock: Does not crack nor loses adherence
17) Asbestos content: 0%
18) Fungal growth: 0%
19) Bacterial growth: 0%
20) VOCs (g/l): 26.850 (computed according to the formulation)
21) Impermeability: 90%

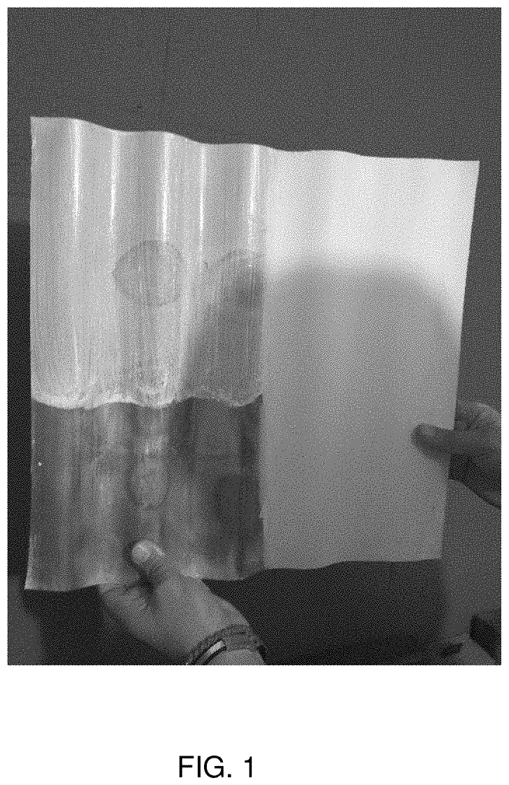

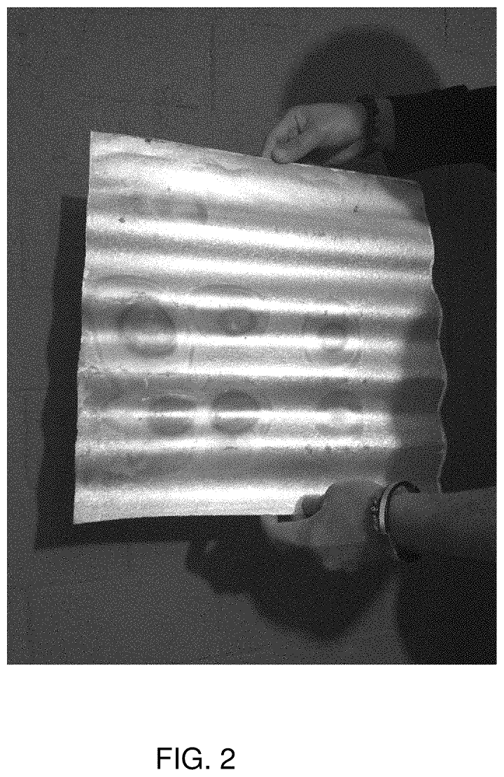

Performance tests of the water-based paint additive are:
1. A zinc sheet 32-gauge (0.25 mm thick) coated with water-based acrylic paint and additive in a 2:1 ratio and directly exposed to torch flame at 600°, the zinc sheet reaching 523° with peaks of 600° without damaging the sheet (FIG. 1).
2. There is an incandescent tone in the reverse side; however, the temperature decreases considerably (FIG. 2).

The results of the performance tests are described in Table 3 below:

TABLE 3
Performance of various water-based paint additives.

| | | | Without additive | | | With additive | | |
|---|---|---|---|---|---|---|---|---|
| | | | Temperature | Temperature | | Temperature | Temperature | |
| | | | of direct | of direct | | of direct | of direct | |
| | | Yield | exposure to | exposure to | Paint | exposure to | exposure to | Paint |
| Brand | Paint type | L/M2 | flame, front | flame, back | reaction | flame, front | flame, back | reaction |
| Sayer | Vinyl acrylic | 5 | 550°-600° | 550°-600° | Burns after | 550°-600° | 140°-170° | Withstands |
| Miahuatlan | | | | | 5-10 seconds | | | 10-20 minutes |
| | | | | | | | | before burning |
| Star Colors | Vinyl | 76 | 550°-600° | 550°-600° | Burns after | 550°-600° | 140°-170° | Withstands |
| | | | | | 5-10 seconds | | | 10-20 minutes |
| | | | | | | | | before burning |
| Comex | Vinyl | 6 | 550°-600° | 550°-600° | Burns after | 550°-600° | 140°-170° | Withstands |
| | | | | | 5-10 seconds | | | 10-20 minutes |
| | | | | | | | | before burning |
| Berel | Vinyl acrylic | 7 | 550°-600° | 550°-600° | Burns after | 550°-600° | 140°-170° | Withstands |
| | | | | | 5-10 seconds | | | 10-20 minutes |
| | | | | | | | | before burning |
| Meridian | water based | 6 | 550°-600° | 550°-600° | Burns after | 550°-600° | 140°-170° | Withstands |
| | enamel | | | | 5-10 seconds | | | 10-20 minutes |
| | | | | | | | | before burning |
| Matisse | Vinyl acrylic | 20 | 550°-600° | 550°-600° | Burns after | 550°-600° | 140°-170° | Withstands |
| | | | | | 5-10 seconds | | | 10-20 minutes |
| | | | | | | | | before burning |
| ProCraft | Vinyl acrylic | 15 | 550°-600° | 550°-600° | Burns after | 550°-600° | 140°-170° | Withstands |
| Sherwin | | | | | 5-10 seconds | | | 10-20 minutes |
| Williams | | | | | | | | before burning |
| EcoORganic | Cactus sap | 2 | NA | NA | NA | 550°-600° | 60°-70° | Withstands |
| | and water | | | | | | | 5-10 minutes |
| EcoPaint DEV | — | 1 | NA | NA | NA | 550°-600° | 140°-170° | Withstands |
| 1.22 | | | | | | | | 20-30 minutes 6 |
| | | | | | | | | ro 7 different times |

The results of viscosity, water absorption, density and adherence were obtained according to the corresponding ASTM standards.

### Definitions

The following definitions are included to provide a clear and consistent understanding of the specification and claims. As used herein, the recited terms have the following meanings. All other terms and phrases used in this specification have their ordinary meanings as one of skill in the art would understand.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five substituents on the ring.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

This disclosure provides ranges, limits, and deviations to variables such as volume, mass, percentages, ratios, etc. It is understood that a range, such as “number 1” to “number 2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation, or limitations not specifically disclosed herein.

Thickening agents are used to thicken the fluid, suspend dispersions of additives in the fluid, and improve the stability of dispersion as a function of temperature and shear history. For example, Carbopol is a synthetic polymer of acrylic acid. Also known as carbomers, they are used as emulsion stabilizers or thickening agents in various aqueous products. They are typically homopolymers of acrylic acid, crosslinked with an allyl ether pentaerythritol, allyl ether of sucrose, or allyl ether of propylene. For carbomers generally, see: www.pharmacopeia.cn/v29240/usp29nf24s0_m13027.html.

1. A water-based paint additive composition comprising:
a) Water;
b) Sodium 2,4,5-trichlorophenolate (Dowicide);
c) Tamol;
d) Titanium dioxide;
e) Calcium carbonate Class B-325;
f) An aqueous antifoaming agent;
g) Rehydrated natural fibers;
h) Carbopol;
i) Sodium methylparaben;
j) Triethanolamine; and
k) Methocel;
wherein the water-based paint additive composition comprises a solid component, the solid component comprising of at least 99% the rehydrated natural fibers (g).

2. The water-based paint additive according to claim 1, wherein the solid component comprises approximately 30% of the water-based paint additive.

3. The water-based paint additive according to claim 1, wherein the rehydrated natural fibers comprise one or more of hemp, coconut, palm, and rubber fibers.

4. The water-based paint additive according to claim 1, wherein the rehydrated natural fibers consist of hemp, coconut, palm, and rubber fibers.

5. The water-based paint additive according to claim 3, wherein the rehydrated natural fibers are present in the composition in the following quantities (per liter):
Hemp: 10 g-1000 g;
Coconut: 10 g-1000 g;
Palm: 10 g-1000 g; and
Rubber: 10 g-1000 g.

6. The water-based paint additive according to claim 1, wherein the water-based paint additive comprises a thermal conductivity of approximately K=0.026-0.029 British thermal units-inch/hour×foot²×° Fahrenheit.

7. The water-based paint additive according to claim 1, wherein the water-based paint additive comprises a Brookfield viscosity of between 40,000-50,000 centipose (CPS).

8. The water-based paint additive according to claim 1, wherein the water-based paint additive comprises a density of approximately 1.22 grams/centimeter³.

9. The water-based paint additive according to claim 1, wherein the water-based paint additive comprises an adherence to concrete of at least 96% and an adherence to metals of at least 99%.

10. The water-based paint additive according to claim 1, wherein the water-based paint additive is flame-retardant.

11. The water-based paint additive according to claim 1, wherein the water-based paint additive reduces a temperature change of a surface to which the additive is applied by approximately 400° C. compared to an uncoated surface when exposed to direct heat.

12. The water-based paint additive according to claim 11, wherein the water-based paint additive is mixed with a water-based paint in approximately a 1:2 ratio.

13. A method for manufacturing a water-based paint additive consisting of:
A.) mixing water at approximately 50 degrees Celsius (° C.) in a mixing device at a first speed and performing the following steps in order to form a first mixture:
i) combining Dowicide, tamol, titanium dioxide, and calcium carbonate Class B-325 with the water without stopping the mixing;
ii) adding an aqueous antifoaming agent and viny resin that is then mixed for approximately 3 minutes;
iii) adding, at approximately 5 minutes intervals, the rehydrated natural fibers, carbopol, and sodium methylparaben;
iv) increasing the mixing speed to a second speed greater than the first speed and adding Triethanolamine that is then mixed for approximately 5 minutes, after which the second speed is decrease to the first speed to form the first mixture;
B) adding methocel to the first mixture as a thickening agent, wherein the thickening agent is pre-prepared as follows:
v) combining water with the methocel and mixing to form a second mixture such that the methocel is present in a concentration of approximately 5% to approximately 10% by weight, wherein the mixing is first in a clockwise direction, stopping the mixing, and then continuing the mixing of the second mixture in a counterclockwise direction;
vi) repeating the mixing of the second mixture of step v for approximately 30 seconds;
vii) after step vi, adding the second mixture to the first mixture to form a third mixture;
C) adding an additional amount of the aqueous antifoaming agent to the third mixture;
viii) continuing the mixing of the third mixture for approximately 40 minutes at the first speed; and
ix) letting the third mixture settle for approximately 20 minutes to form the water-based paint additive.

14. The method of claim 13 wherein the rehydrated natural fibers comprise one or more of hemp, coconut, palm, and rubber fibers.

15. The method of claim 13 wherein the rehydrated natural fibers consist of hemp, coconut, palm, and rubber fibers.

16. The method of claim 14 wherein the rehydrated natural fibers are present in the composition in the following quantities (per liter):
Hemp: 10 g-1000 g;
Coconut: 10 g-1000 g;
Palm: 10 g-1000 g; and
Rubber: 10 g-1000 g.

17. The method according to claim 13, wherein the water-based paint additive comprises a thermal conductivity of approximately K=0.026-0.029 British thermal units-inch/hour×foot²×° Fahrenheit.

18. The method according to claim 13, wherein the water-based paint additive comprises a Brookfield viscosity of between 40,000 and 50,000 centipose (CPS).

19. The method according to claim 13, wherein the water-based paint additive comprises a density of approximately 1.22 grams/centimeter³.
